(19) United States
(12) Patent Application Publication
(10) Pub. No.: US 2026/0238592 A1
(43) Pub. Date: Aug. 13, 2026

(54) ENCAPSULATION DEVICE, COMMUNICATION SYSTEM, ENCAPSULATION METHOD, AND ENCAPSULATION PROGRAM

(71) Applicant: NTT, Inc., Tokyo (JP)

(72) Inventor: Hitoshi Irino, Musashino-shi, Tokyo (JP)

(21) Appl. No.: 19/155,860

(22) PCT Filed: Feb. 21, 2023
(86) PCT No.: PCT/JP2023/006203

§ 371 Date: Aug. 12, 2025

(51) Int. Cl. H04L 45/745; H04L 12/46; H04L 45/741

(52) U.S. Cl. CPC H04L 45/745; H04L 12/4633; H04L 45/741

(57) ABSTRACT

A CE (33) used in a communication system (100) configured to transmit an outgoing packet from a transmitting device (34) to a receiving device (31) includes an SR tunneling unit (33b) configured to receive the outgoing packet with an IPV4 header attached from the transmitting device (34), generate a second parameter group obtained by converting a first parameter group read from the IPV4 header on the basis of a MAP rule (33c), and encapsulate an IPV6 header including the second parameter group and the MAP rule (33c) into the IPv4 header of the outgoing packet to transmit the outgoing packet to the BR (32) configured to decapsulate the outgoing packet.

### TECHNICAL FIELD

The present invention relates to an encapsulation device, a communication system, an encapsulation method, and an encapsulation program.

### BACKGROUND ART

New allocations of IP addresses in IPv4 have been exhausted, and IPv6-only networks have been constructed. Since many existing communication destinations belong to IPv4 networks, a conversion device is required to connect devices that belong to IPv6-only networks to devices that belong to IPv4 networks. A communication method using this conversion device will be described as IPv4 over IPv6 communication since IPv4 communication is carried out over IPv6 networks.

A border relay (BR) and a customer edge (CE) are defined as devices used for the IPv4 over IPv6 communication.
A BR is a device in a telecommunications carrier network. A telecommunications carrier network is a network with both IPv6 and IPv4 connectivity operated by carriers that provide communication connectivity.
A CE is a customer side device which is a terminal device connected to a BR. In addition, in the present specification, a device referred to as a CE is also Customer Premises Equipment (CPE) since it is terminal equipment placed on a customer side of a telecommunications carrier.

As technical methods for conversion devices, there are the following standard techniques depending on a location of a network address translation (NAT) table.
(1) Stateful NAT is a method in which a NAT table is held on a BR side to perform state management. For specifications of stateful NAT, for example, there are standard techniques such as Dual Stack-Lite (DS-Lite) (RFC 6333) and 464XLAT (RFC 6877).
(2) Stateless NAT is a method in which a NAT table is held on a CE side and thus state management on a BR side is not required. For stateless NAT, for example, there are standard techniques such as lightweight 4over 6(lw4o6 ) (RFC 7596), and MAP-E and MAP-T (RFC 7599) described in NPL 1. Although lw4o6 has a different origin, it is almost the same technical method as MAP-E. When there is a local IPv4 NW using private addresses under a CE, the CE performs NAT (NAT44: a method for converting an IPv4 address into another IPv4 address).

In addition, as methods for causing an IPv6 packet to include information of an IPv4 packet, there are the following methods.
(a) An encapsulation method is a method for inserting an IPv4 packet into a payload of an IPv6 packet, and there are standard techniques such as DS-Lite, lw4o6, and MAP-E, for example.
(b) A translation method is a method for converting an IPv4 address into an IPv6 address, and there are standard techniques such as 464XLAT and MAP-T, for example.

An IPv4 over IPv6 method that adopts (2) stateless NAT and (a) an encapsulation method will be described below.

MAP-E is a method used by telecommunications carriers to provide IPv4 connectivity over IP over Ethernet (IPoE (registered trademark)) (IPv6 only). Telecommunications carriers are, for example, Internet service providers (ISPs) and virtual network enablers (VNEs).

MAP-E is an address sharing method in which one IPv4 address is shared by a plurality of users, and embeds an allocated port share IDs (PSIDs) in ports to prevent duplication among the plurality of users. Also, the number of ports allocated to one user is limited depending on a sharing rate.

FIG. 11 is an explanatory diagram for showing an operation example of MAP-E.

In a communication system 100B shown in FIG. 11, a receiving device 11, a BR 12, a CE 13, and a transmitting device 14 are connected to each other via a network.

The transmitting device 14 has a private address (192.168.1.1) and has only IPv4 connectivity.

The receiving device 11 is a device serving as a transmission destination of data packets from the transmitting device 14.

In the following, a communication direction from the transmitting device 14 to the receiving device 11 will be referred to as an “outgoing direction,” and a communication direction from the receiving device 11 to the transmitting device 14 will be referred to as a “return direction.” In addition, a packet in the outgoing direction will be referred to as an outgoing packet, and a packet in the return direction will be referred to as a return packet.

The CE 13 houses the transmitting device 14 and has a NAT function unit 13a and a MAP-E function unit 13b.

The NAT function unit 13a provides a NAT function (a function of the above-mentioned NAT44 method). That is, the NAT function unit 13a performs IP address conversion (conversion between a private address and a global address) conversion and port conversion in accordance with a network address and port translation (NAPT) table present in its own device.

The MAP-E function unit 13b provides an IPv6 encapsulation function based on the MAP-E method. That is, the MAP-E function unit 13b converts an <IPv4 address and a port number> in an outgoing packet received from the transmitting device 14 into an IPv6 address on the basis of a MAP rule 22.

Here, a conversion destination's IP address and port number converted by the NAT function unit 13a become an IP address and a port number derived by a MAP rule 23 managed by the MAP-E function unit 13b. Also, carriers ensure contents on the basis of the MAP rule 23 allocated to the CE 13 and the MAP rule 22 allocated to the BR 12.

Then, using the MAP rule 22, the BR 12 performs validation (verification) of whether or not the converted IPv6 address in the outgoing packet received from the CE 13 matches the <IPv4 address and the port number>before conversion. Specifically, the validation compares a combination of a PSID and an IPv4 address inside a capsule (an IPv4 header) with those outside the capsule (an IPv6 header) to check whether or not they coincide with each other. On the other hand, validation of a return packet is not required.

Specific processing of outgoing packets and return packets will be described below with reference to packet diagrams of FIGS. 12 and 13.

Outgoing packets are as follows (FIG. 11).
An outgoing packet P11 from the transmitting device 14 to the NAT function unit 13a
An outgoing packet P12 from the NAT function unit 13a to the MAP-E function unit 13b
An outgoing packet P13 from the MAP-E function unit 13b to the BR 12
An outgoing packet P14 from the BR 12 to the receiving device 11 Return packets are as follows (FIG. 11).
A return packet P21 from the receiving device 11 to the BR 12
A return packet P22 from the BR 12 to the MAP-E function unit 13b
A return packet P23 from the MAP-E function unit 13b to the NAT function unit 13a
A return packet P24 from the NAT function unit 13a to the transmitting device 14

Also, for the outgoing packet P12 and the return packet P23, intra-device communication (communication in the CE 13) between the NAT function unit 13a and MAP-E function unit 13b is performed, and thus data structures other than packet formats including the headers as shown in FIGS. 12 and 13 may also be used in reality.

However, in order to make the description easier to understand, the outgoing packet P12 and the return packet P23 will also be described as examples of the same packet format as that of other packets.

FIG. 12 is a packet diagram showing details of header parts of the outgoing packets shown in FIG. 11.

In the packet diagrams of FIGS. 12 and 13, lateral widths are illustrated as 32 bits. In addition, in the following description of the packet diagrams, for regions (hereinafter referred to as “cells”) divided in a vertical direction and a horizontal direction in illustrated packet headers, a row number indicates an order of a row from the top in the vertical direction, and a column number indicates an order of a column from the left in the horizontal direction.

For example, the cell “Total Length” in the first row and the fourth column of the outgoing packet P11 indicates a total length of the outgoing packet P11, and the cell “TTL” in the third row and the first column of the outgoing packet P11 indicates a Time to Live of the outgoing packet P11.

The CE 13 receives the outgoing packet P11, which is an IPv4 packet sent from the transmitting device 14. The NAT function unit 13a converts the outgoing packet P11 into the outgoing packet P12. The MAP-E function unit 13b converts the outgoing packet P12 into the outgoing packet P13 on the basis of the IPv6 Prefix “2001:db8:1012:34::/56” allocated from a telecommunications carrier and the MAP rule 23 below.
Rule IPv6 Prefix=2001:db8:1000::/40
Rule IPv4 Prefix=192.0.2.0/24
EA-bit Length: 16
PSID Length=8
PSID offset=6

Conversion processing to the outgoing packet P12 will be described below.

The allocated IPv6 Prefix (2001:db8:1012:34::/56) conforms to the Rule IPv6 Prefix (2001:db8:1000::/40) by an amount of a prefix length (40 bits indicated by “/40”) of the Rule IPv6 Prefix.

In this case, “EA bits” are a difference (exclusive OR) between the IPv6 prefixes, that is, 0x1234 of the lower 16 bits of the allocated IPv6 Prefix. “IPv4 Address suffix” is the higher bits of the EA bits, and its bit length is 32 (a bit length of an IPv4 address). “PSID” is the lower bits of the EA bits, and PSID Length=8.

These 8 bits are (a bit length of an IPv4 address=32)-(24 indicated by a prefix length “/24” of the Rule IPv4 Prefix).

Thus, the IPv4 Address suffix is 0x12 (18 as a decimal number). Accordingly, the above 24 bits are 192.0.2.0 (Rule IPv4 Prefix), the lower 8 bits are 18 (IPv4 Address suffix), and thus the global address that the CE 13 may use is “192.0.2.18.” This “192.0.2.18” becomes “Src v4 Addr=192.0.2.18” in the fourth row of the outgoing packet P12. In addition, 0x34 which is the lower 8 bits of the EA bits become PSID. PSID Offset is 6 bits.

Further, for the purpose of excluding well know ports less than 1024, the higher 6 bits of the PSID Offset is recommended to start from 1. Accordingly, in a port number (Source Port) in the sixth row of the outgoing packet P12, the higher 6 bits have a value of 0b000001 or more and 0b111111 or less, the middle 8 bits are 0x34=0b00110100 in the PSID, and the lower 2 bits have a value of 0b00 or more and 0b11 or less.

An operating system (OS) of the CE 13 determines any value as the port number from these selectable values. In the present example, as the smallest selectable value, “0b 0000010011010000,” that is, 1232 in decimal notation, becomes a source port number after NAT44 conversion of the outgoing packet P12.

The MAP-E function unit 13b converts the outgoing packet P12 into the outgoing packet P13 by encapsulating the IPv4 packet into IPv6. The MAP-E function unit 13b transfers the outgoing packet P13 to the BR 12 via an IPv6 network.

Conversion processing to the outgoing packet P13 will be described below.

For the Source IPv6 Address (“Source” in the figure) shown in the third to sixth rows of the outgoing packet P13 (FIG. 12), the higher 56 bits become the allocated IPv6 Prefix allocated from a telecommunications carrier. The lower 64 bits are Interface-ID, and thus in the case of the outgoing packet P13, 8 bits following the allocated IPv6 Prefix become Subnet, but in the case of MAP-E, 0 is used (5.2. Basic Mapping Rule (BMR) in NPL 1).

As for the Interface-ID of the outgoing packet P13, the higher 16 bits become 0, the middle 32 bits become IPv4 Address, and the lower 16 bits become PSID (6. The IPv6 Interface Identifier in NPL 1). This determines the Source IPv6 Address.

On the other hand, the Destination IPv6 Address in the seventh row of the outgoing packet P13 becomes an IP address allocated to the BR 12 serving as a tunnel connection destination. In addition, the outgoing packet P12 is encapsulated on and after the eighth row of the outgoing packet P13.

Also, although the NAT function unit 13a and the MAP-E function unit 13b are described separately in FIG. 11, they may be operated integrally.

Further, in the example of FIG. 11, the outgoing packet P12 between the NAT function unit 13a and the MAP-E function unit 13b is described as the packet diagram of FIG. 12. However, in reality, the functional units may be implemented in various ways inside the CE 13 device, but a series of conversion operations may be performed without transferring the packets between the functional units.

The BR 12 performs validation of the received outgoing packet P13 through the following items.
(Procedure 1) Extract the Source IPv4 Address or IPv4 Prefix and the PSID from the Source IPv6 Address of the outgoing packet P13.
(Procedure 2) Extract the Source IPv4 Address and the Source Port (including the PSID) from the outgoing packet P12 encapsulated inside the outgoing packet P13.
(Procedure 3) Confirm whether or not each item extracted in Procedure 1 coincides with (matches) each item extracted in Procedure 2.

Then, when they do not coincide with each other in Procedure 3, the BR 12 discards the outgoing packet P13 (“8.1. Receiving Rules” in NPL 1). On the other hand, when they coincide with each other in Procedure 3, the BR 12 removes the IPv6 header of the outgoing packet P13 and transfers the decapsulated outgoing packet P14 (IPv4 packet) obtained by extracting the IPv4 packet to the receiving device 11.

The return packets will be described below.

FIG. 13 is a packet diagram showing details of header parts of the return packets in FIG. 11.

The receiving device 11 sends the return packet P21 converted from the received outgoing packet P14 to the BR 12.

The return packet P21 is a packet in which the Source IPv4 Address of the outgoing packet P14 is exchanged with the Destination IPv4 Address and the Source Port of the outgoing packet P14 is exchanged with the Destination Port.

The BR 12 converts the return packet P21 received from outside its MAP domain (receiving device 11) into the return packet P22, which is an IPv6 packet, and transfers the return packet P22 to the CE 13. For that reason, the BR 12 generates the Destination IPv6 Address of the return packet P22 on the basis of the Destination IPv4 Address in the return packet P21 and the higher layer (such as TCP/UDP) Destination Port. This generation processing is described in 5.4 “Destinations outside the MAP Domain” in NPL 1.

The Source IPv6 Address of the return packet P22 becomes the address of the BR 12. As a result of calculation of MAP, the Destination IPv6 Address of the return packet P22 becomes the same as the Source IPv6 Address of the outgoing packet P13.

The MAP-E function unit 13b of the CE 13 performs decapsulation of the received return packet P22 and extracts the IPv4 packet inside as the return packet P23. The NAT function unit 13a of the CE 13 performs NAT44 processing on the return packet P23 on the basis of the NAPT table and transfers the resulting return packet P24 to the transmitting device 14.

An operation example of MAP-E has been described above with reference to FIGS. 11 to 13.

Incidentally, independently from the IPv4 over IPv6 communication function, there is Segment Routing over IPv6 (SRv6) as a technique of designating a route for relaying a packet on a network and an activating function on the route (NPLs 2, 3, and 4). SRv6 is a technique for making it possible to use Segment Routing originally preceded by MPLS even in an IPv6 underlay, and an extended header to be used is IPv6 Segment Routing Header (SRH) (NPL 3). Further, SRv6 is extended by the definition of Network Programming (NPL 4), and thus Layer 2 Virtual Private Network (L2VPN), L3VPN, or the like can be realized.

In SRv 6, the segment ID (SID) is 128 bits, which increases a packet header length and makes hardware (ASIC) processing difficult, and thus a compression method has been proposed (NPL 5).

### CITATION LIST

### Non Patent Literature

[NPL 1] Internet Engineering Task Force (IETF), “Mapping of Address and Port with Encapsulation (MAP-E) ,” [online], [retrieved on Feb. 13, 2023], July 2015, RFC 7597, Internet <URL:https://datatracker.ietf.org/doc/rfc7597/> [NPL 2] IETF, “Segment Routing Architecture,” [online], [retrieved on February 13, 2023], July 2018, RFC 8402, Internet <URL:https://datatracker.ietf.org/doc/rfc8402/> [NPL 3] IETF, “IPv6 Segment Routing Header (SRH),” [online], [retrieved on Feb. 13, 2023], March 2020, RFC 8754, Internet <URL:https://datatracker.ietf.org/doc/rfc8754/> [NPL 4] IETF, “Segment Routing over IPv6 (SRv6) Network Programming,” [online], [retrieved on Feb. 13, 2023], February 2021, RFC 8986, Internet <URL:https://datatracker.ietf.org/doc/rfc8986/> [NPL 5] W. Cheng, Ed. et al., “Compressed SRv6 Segment List Encoding in SRH,” [online], [retrieved on Feb. 13, 2023], Jul. 11, 2022, draft-ietf-spring-srv6-srh-compression-02, Internet <URL:https://datatracker.ietf.org/doc/draft-ietf-spring-srv6-srh-compression/02/>

### SUMMARY OF INVENTION

### Technical Problem

As described with reference to FIG. 11, the BR 12 functions as the device that performs validation (verification) and decapsulation of an outgoing packet. That is, a route of the outgoing packet from the transmitting device 14 to the receiving device 11 must pass through the BR 12 along the way. Here, when the receiving device 11 and the BR 12 are disposed at separated places, the route of the outgoing packet becomes a detour route by passing through the BR 12, which is inefficient.

Thus, a main object of the present invention is to provide a mechanism for efficiently setting a route of an encapsulated packet.

### Solution to Problem

In order to solve the above problems, an encapsulation device of the present invention has the following features.

The present invention is an encapsulation device used in a communication system for transmitting a data packet from a transmitting device to a receiving device, wherein the encapsulation device includes:
a tunneling unit configured to receive the data packet with an inner header attached from the transmitting device, generate a second parameter group obtained by converting a first parameter group read from the inner header on the basis of a conversion rule, and
encapsulate an outer header including the second parameter group and the conversion rule into the inner header of the data packet to transmit the encapsulated data packet to a decapsulation device configured to decapsulate the data packet.

### Advantageous Effects of Invention

According to the present invention, a mechanism for efficiently setting a route of an encapsulated packet can be provided.

### BRIEF DESCRIPTION OF DRAWINGS

FIG. 1 is a configuration diagram of a communication system according to the present embodiment.

FIG. 2 is a hardware configuration diagram of each device of the communication system according to the present embodiment.

FIG. 3 is a flowchart showing an overview of processing of the communication system according to the present embodiment.

FIG. 4 is a packet diagram showing a packet output by a MAP-E function unit.

FIG. 5 is a packet diagram showing a packet obtained by converting the packet of FIG. 4 into SRv6.

FIG. 6 is a packet diagram showing a packet obtained by compressing the packet of FIG. 5.

FIG. 7 is a packet diagram of a packet generated by an SR tunneling unit according to the present embodiment.

FIG. 8 is a packet diagram showing details of an interface part in FIG. 7 according to the present embodiment.

FIG. 9 is a diagram showing verification code according to the present embodiment.

FIG. 10 is a diagram showing pseudocode inserted into pseudocode of FIG. 9 according to the present embodiment.

FIG. 11 is an explanatory diagram showing an operation example of MAP-E. FIG. 12 is a packet diagram showing details of header parts of outgoing packets in FIG. 11.

FIG. 13 is a packet diagram showing details of header parts of return packets in FIG. 11.

### DESCRIPTION OF EMBODIMENTS

One embodiment of the present invention will be described in detail below with reference to the drawings.

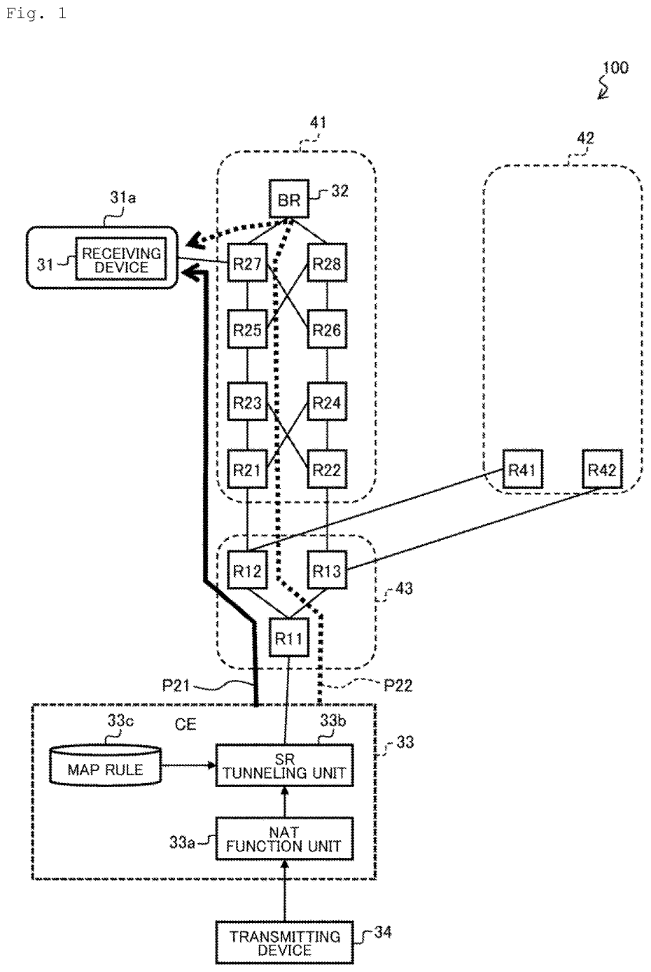

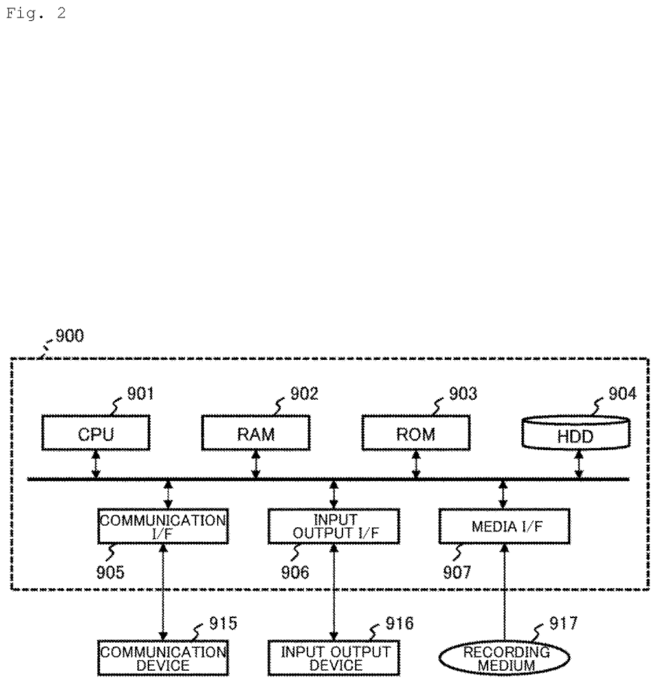

FIG. 1 is a configuration diagram of a communication system 100.

Hereinafter, as an example of the communication system 100, the MAP-E method described in NPL 1 will be adopted on an SRv6 network, and a format equivalent to the Shared IPv4 Address of NPL 1 will be exemplified. The communication system 100 of the present embodiment realizes an address sharing type IPv4 over IPv6 technique as SRv6 Network Programming. The communication system 100 mainly has the following two features.
An address representation format for performing decapsulation at any node corresponding to SRv6 is provided.
Encapsulation overhead of a packet is reduced and transfer efficiency is improved.

Also, a path P22 shown by a broken line arrow in FIG. 1 passes through a CE 33→a router R11→R12→R21→R23→R25→R27→BR 32 (validation here)→R27→an external AS 31a→a receiving device 31 in order. This path P22 is a method of executing validation using the existing BR 32, and the route is not optimized since it passes through the R27 twice, and the like.

In addition, a data packet after decapsulation in the BR 32 needs to be subjected to IPv4 communication through the BR 32→R27, which requires efforts of the R27 to operate a dual stack of IPv6 and IPv4.

On the other hand, a path P21 shown by a solid line arrow in FIG. 1 passes through the CE 33→the router R11→R12→R21→R23→R25→R27 (validation here)-the external AS 31a-the receiving device 31 in order. This path P21 utilizes the mechanism of the present embodiment that enables validation to be executed at any node, and the route is optimized.

Also, the router R27 performing validation is assumed to have 2001:db8:1fff:1::as an anycast address, which is equal to the BR 32. In addition, in order to make the path P21 operable, the route is required to be the following cases.
A case in which the route is “5.3. Global IPv4 over SRv6 Core” of rfc 9252, that is, AFI=1/SAFI=1 of “6.1. IPv4 over IPv6 Core” of RFC 8950.
A case of no VPN. On the other hand, in the case of VPN, it is impossible since VRF needs to be shared by different devices.

In the communication system 100, the receiving device 31, the BR 32, the CE 33, and a transmitting device 34 are connected to each other via a network.

The transmitting device 34 has only IPv4 connectivity, and an IPv4 private address is allocated thereto.

The receiving device 31 is a device serving as a transmission destination of a data packet from the transmitting device 34. Hereinafter, a communication direction from the transmitting device 34 to the receiving device 31 will be referred to as an “outgoing direction,” and a communication direction from the receiving device 31 to the transmitting device 34 will be referred to as a “return direction.” In addition, a packet in the outgoing direction will be referred to as an outgoing packet, and a packet in the return direction will be referred to as a return packet.

The CE 33 houses the transmitting device 34 and has a NAT function unit 33a, an SR tunneling unit 33b, and MAP rule 33c.

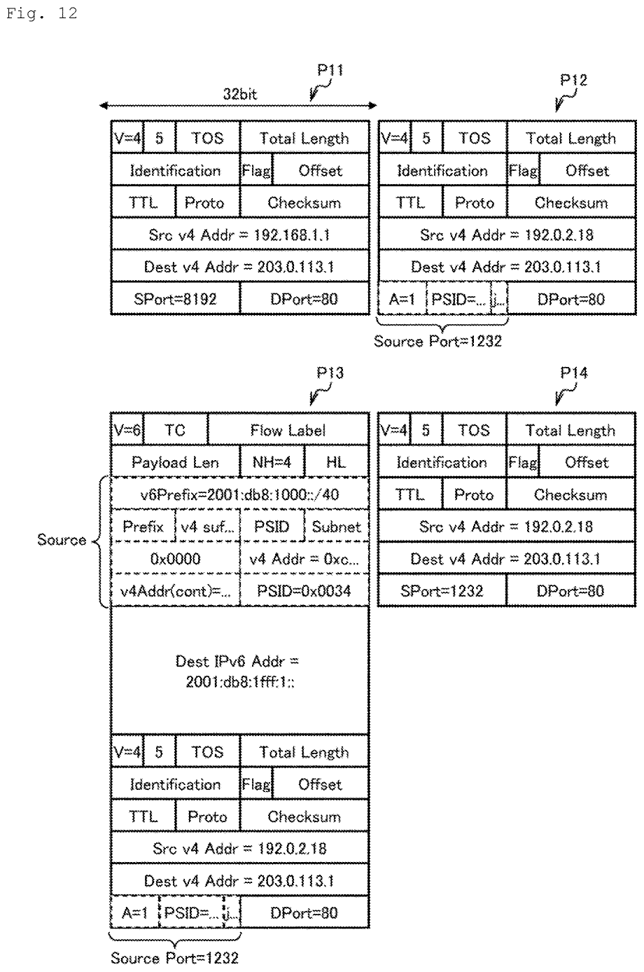

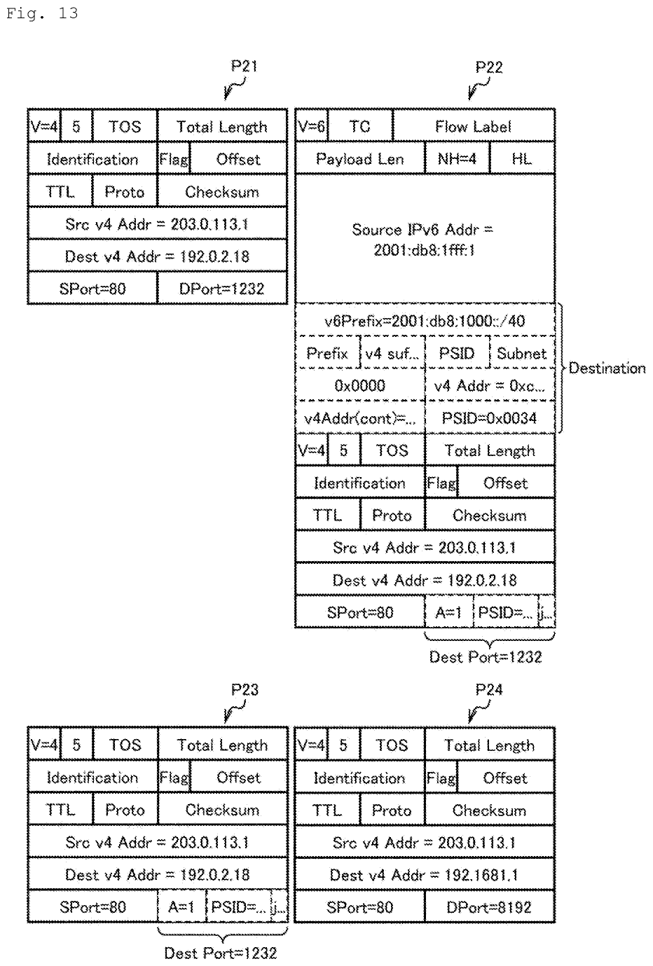

The NAT function unit 33a provides a NAT 44 function similarly to the NAT function unit 13a in FIG. 11.

The SR tunneling unit 33b provides an IPv6 encapsulation function based on the MAP-E method and handles an address and port sharing technique equivalent to MAP-E integrally with SRv6. The SR tunneling unit 33b converts an <IPv4 address and a port number> in an outgoing packet received from the transmitting device 34 into an IPv6 address on the basis of the MAP rule 33c.

Also, the SR tunneling unit 33b may be configured to integrate an IPv6 encapsulation function (tunneling unit) based on the MAP-E method and an SRv6 function (SR unit), or may be configured to have the tunneling unit in the CE 33 and the SR unit in the router R11 of another device or the like.

Here, main similarities and differences between the MAP-E function unit 13b in FIG. 11 and the SR tunneling unit 33b in FIG. 1 are as follows.
The MAP-E function unit 13b and the SR tunneling unit 33b are common in that they perform IPv6 encapsulation. The MAP-E function unit 13b performs encapsulation by referring to the MAP rule 22 which can be acquired from the CE 13, and the SR tunneling unit 33b performs encapsulation by referring to the MAP rule 33c which can be acquired from the CE 33.
The BR 12 performs validation of the outgoing packet P13 by referring to the MAP rule 23 set in advance by an administrator. For that reason, the device that performs validation is limited to the BR 12. On the other hand, the SR tunneling unit 33b further embeds at least a part of the MAP rule 33c in the encapsulated outgoing packet. Thus, since the device that performs validation of the outgoing packet P13 can read the MAP rule 33c from inside the received outgoing packet, any node to which the MAP rule 23 is not set in advance can function as the device.
The MAP-E function unit 13b does not have an SRv6 function, and the device that sets SRv6 to the outgoing packet P13 is a relay device (for example, the router R21 in FIG. 1) present in the outgoing direction from the CE 13 toward the BR 12. On the other hand, the SR tunneling unit 33b also integrates the SRv6 function.

Also, it is assumed that some of address prefixes held by a provider network 41 in FIG. 1 are distributed from the router R11 using Dynamic Host Configuration Protocol (DHCP) v6 Prefix Delegation (PD) or the like. The routers R12 and R13, which are the higher AS border routers (ASBRs) of the router R11 are connected to the provider network 41 via inter-AS connection. The provider network 41 will be described below as an example. In addition, it is assumed that the routers R12 and R13 are also connected to another provider network 42, and the router R11 distributes addresses to customers using DHCPv6-PD instead of the provider networks 41 and 42.

Further, it is standardized that the MAP rule 33c is distributed as a DHCP option, but it may be implemented using alternative methods such as acquisition from a Hypertext Transfer Protocol (HTTP) server or the like. Similarly, the alternative methods can be used in the present embodiment, and a specific method thereof is not limited.

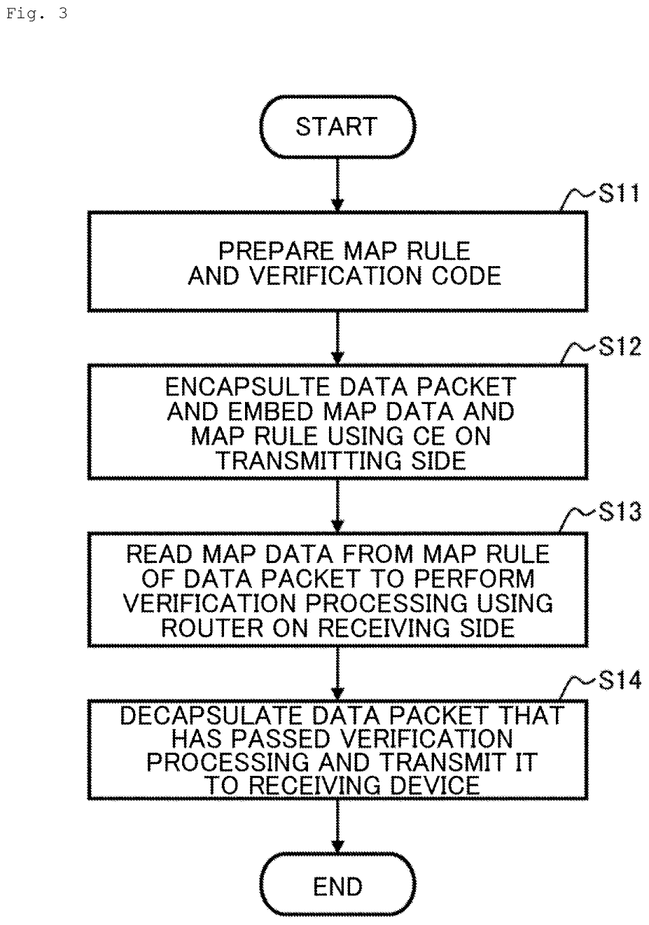

FIG. 2 is a hardware configuration diagram of each device of the communication system 100.

Each device of the communication system 100 (the receiving device 31, the BR 32, the CE 33, the transmitting device 34, and each of the routers R11 to R28) is configured as a computer 900 including a CPU 901, a RAM 902, a ROM 903, an HDD 904, a communication I/F 905, an input output I/F 906, and a media I/F 907.

The communication I/F 905 is connected to an external communication device 915. The input output I/F 906 is connected to an input output device 916. The media I/F 907 reads and writes data from and to a recording medium 917.

Further, the CPU 901 controls each unit by executing a program (also called an application, or an app for short) loaded into the RAM 902. In addition, this program can also be distributed via a communication line, or recorded on the recording medium 917 such as a CD-ROM and distributed.

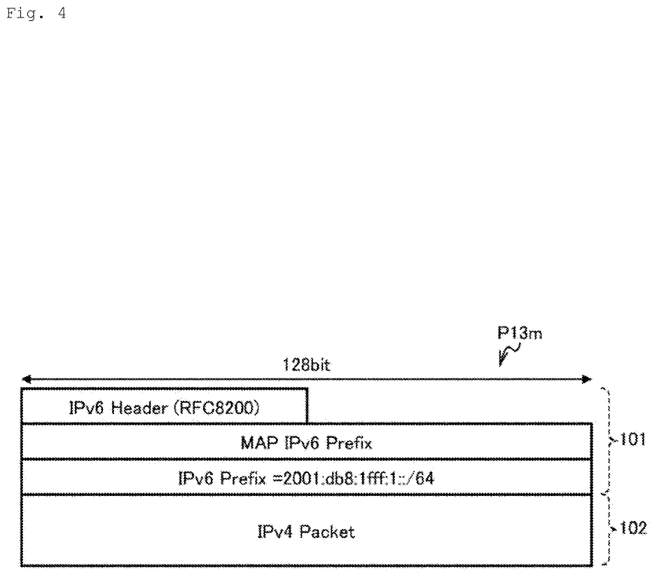

FIG. 3 is a flowchart showing an outline of processing of the communication system 100.

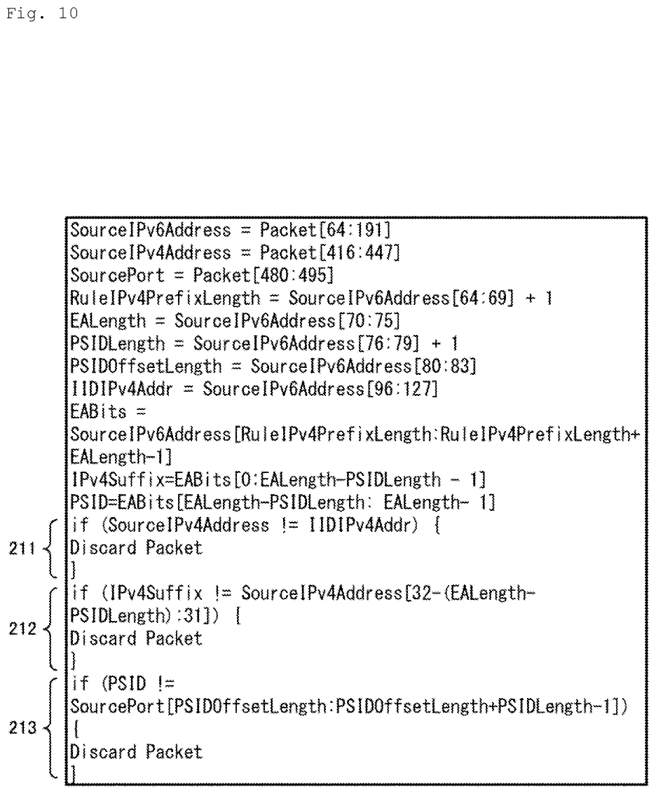

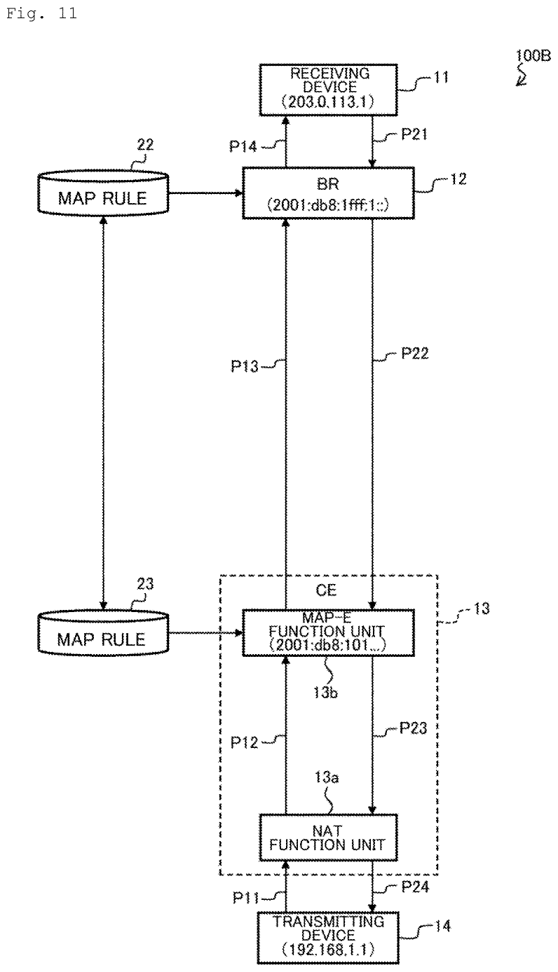

First, the administrator of the communication system 100 prepares the MAP rule 33c to be read by the CE 33 and a verification code (which will be described later in FIGS. 9 and 10) to be executed by a device that performs decapsulation (validation) (S11). Also, although the device that performs decapsulation has been illustrated as the router R27 in FIG. 1, but it may be the BR 32.

The CE 33 on a transmitting side of an outgoing packet embeds the following information in an IPv6 header, to which the following information is added along with encapsulation, of the outgoing packet (data packet) received from the transmitting device 34 (S12).
Data to which the MAP rule 33c is applied (hereinafter referred to as “MAP data”)
At least a part of the MAP rule 33c

That is, the processing of S12 is as follows.

The CE (encapsulation device) 33 used in the communication system 100 that transmits the outgoing packet from the transmitting device 34 to the receiving device 31 has the SR tunneling unit 33b. The SR tunneling unit 33b receives the outgoing packet to which an IPv4 header (inner header) is attached from the transmitting device 34, and generates a second parameter group (MAP data) obtained by converting a first parameter group read from the IPv4 header on the basis of the MAP rule 33c. Then, the SR tunneling unit 33b encapsulates an IPv6 header (outer header) including the second parameter group and the MAP rule 33c into the IPv4 header of the outgoing packet, and transmits the outgoing packet to the BR (decapsulation device) 32 that decapsulates the outgoing packet.

Also, the SR tunneling unit 33b may include information indicating a bit length of each parameter group constituting the second parameter group in the IPv6 header as the MAP rule 33c.

In addition, the SR tunneling unit 33b may include the second parameter group and the MAP rule 33c in its own address information in the IPv6 header and encapsulate the outgoing packet.

Further, the SR tunneling unit 33b may further include address information indicating a relay route to the BR 32 through which the outgoing packet passes in the IPv6 header encapsulated in the outgoing packet and encapsulate the outgoing packet.

A router (router R27 in FIG. 1) on a receiving side of the outgoing packet reads the MAP rule 33c embedded in the outgoing packet (data packet) received from the CE 33, and reads MAP data in the data packet from the MAP rule 33c to perform verification (S13).

Then, the router in S13 decapsulates the data packet that has passed the verification processing and transfers it to the receiving device 31 (S14).

That is, the processing of S13 is as follows.
The BR 32 decapsulates the IPv6 header of the encapsulated outgoing packet received from the CE 33, and acquires the second parameter group from the IPv6 header on the basis of the MAP rule 33c included in the IPv6 header. Then, the BR 32 compares the first parameter group read from the IPv4 header of the decapsulated outgoing packet with the acquired second parameter group, thereby performing the verification processing for determining whether the outgoing packet is to be discarded or transferred to the receiving device 31.

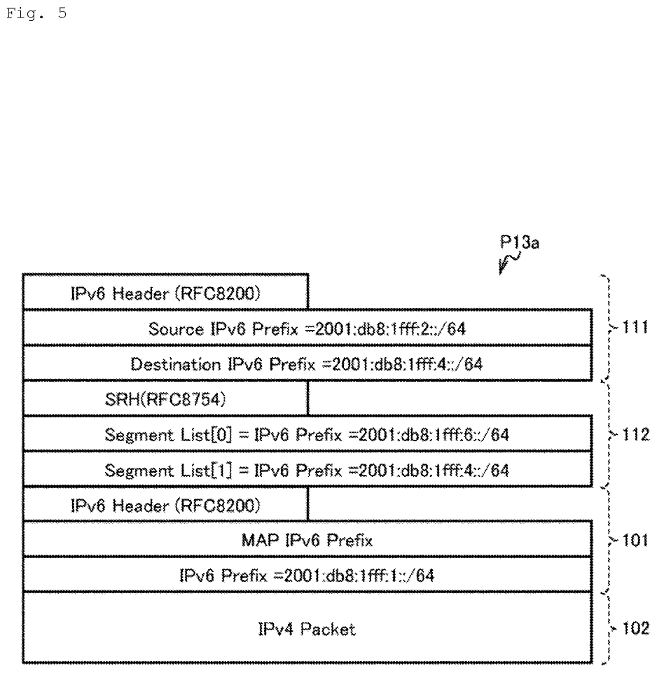

Packets used by the communication system of FIG. 11 will be described below with reference to the packet diagrams shown in FIGS. 4 to 6. In the packet diagrams of FIGS. 4 to 7, lateral widths are 128 bits.

FIG. 4 is a packet diagram showing a packet P13m output by the MAP-E function unit 13b.

The packet P13m is configured by encapsulating a user's an IPv4 packet 102 (specific description about cells is omitted) with an IPv6 header of MAP-E 101. The IPv6 header of MAP-E 101 includes the following information.
IPv6 header (RFC 8200 standard) in a first row
Source Address (128 bits) in a second row
Destination Address (128 bits) in a third row The IPv6 header (RFC 8200 standard) in the first row includes the following information.
Version (4 bits)
Traffic Class (8 bits)
Flow Label (20 bits)
Payload Length (16 bits)
Next Header (8 bits)
Hop Limit (8 bits)

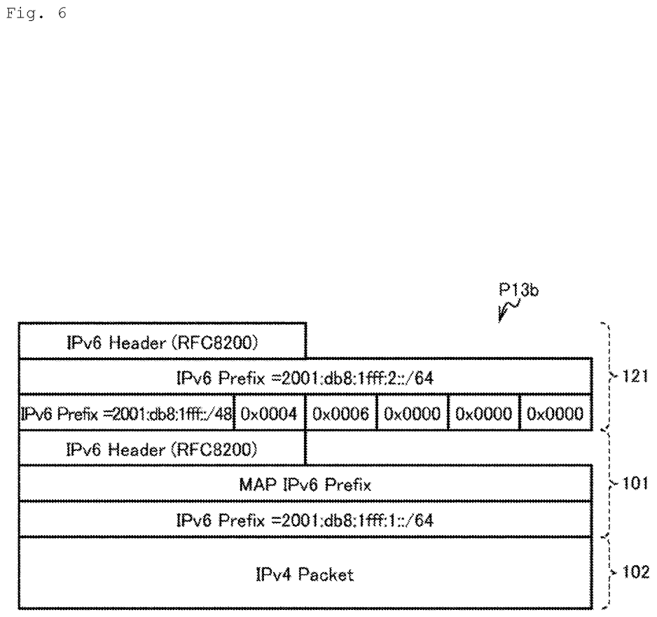

FIG. 5 is a packet diagram showing a packet P13a obtained by converting the packet P13m of FIG. 4 into SRv6 at a relay node (for example, the router R21). The packet P13a includes the following information:
An IPv6 header 111 for SRv6 in first to third rows includes an IPv6 header (RFC 8200 standard), a transmission source address with MAP data embedded, and a destination address of the BR 32.
An SRH 112 for SRv6 in fourth to sixth rows includes, in addition to a header format (RFC 8754 standard) of the SRH, for example, addresses of the routers R25 and R27 as routers for relaying to a destination address of the router R27. That is, the SRH (NPL 3) that explicitly designates the content to “reach the BR 32 via the routers R25 and R27” as a route is inserted into the packet P13a by the SRv6 (NPL 4) executed by the router R21.
The IPv6 header of MAP-E 101 in seventh to ninth rows and the user's IPv4 packet 102 in a tenth row are the same information as the packet P13m of FIG. 4. Since the information required for these MAP-Es is not supported by the SRV6 function, the information is embedded in a different location from the IPv6 header 111 for SRv6 and the SRH 112 for SRV6.

Also, the header format (RFC 8754 standard) of the SRH includes the following information.
Next Header (8 bits)
Hdr Ext Len (8 bits)
Routing Type (8 bits)
Segments Left (8 bits)
Last Entry (8 bits)
Flags (8 bits)
Tag (16 bits)

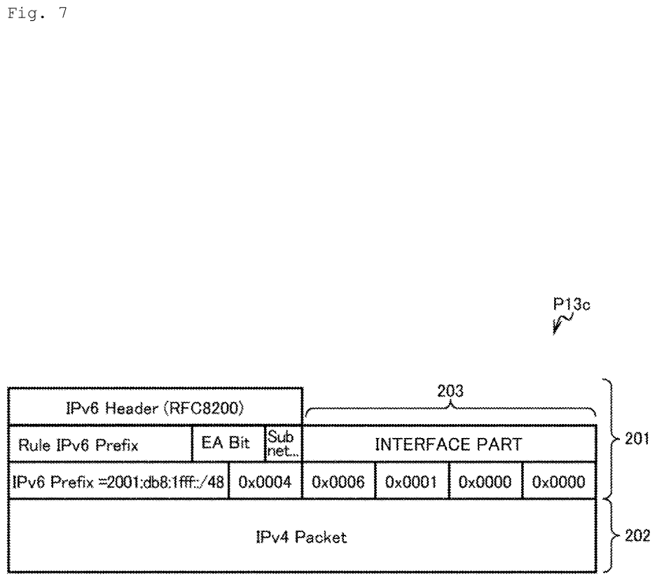

FIG. 6 is a packet P13b obtained by compressing the packet P13a of FIG. 5.

First, SRv 6 in the packet P13 a is a 128-bit SID, which is not suitable for hardware processing such as an application specific integrated circuit (ASIC) due to its large overhead and long SID length. For that reason, there is the following compression method (NPL 5) for SRv6.

In the packet P13b, a first half (the IPv6 header 111 for SRv6 and the SRH112 for SRv6) of the packet P13a is compressed as a compressed SRH 121 for SRv6. A second half of the packet P13b is the same as a second half of the packet P13a.

First and second rows of the compressed SRH 121 for SRv6 are the same as those of the IPv6 header 111 for SRv6.

In “Destination IPv6 Address” in a third line of the compressed SRH 121 for SRv6, information is embedded using NEXT-C-SID Flavor to pass through routers R25 and R27, and the SRH is omitted using H.Encaps.RED.

Also, since MAP-E is not the SRv6 function, the function (End. DT4) defined in SRv6 Network Programming cannot meet the requirements for MAP-E validation. For that reason, the packet P13a of FIG. 5 obtained by encapsulating packet P13m of FIG. 4 into SRv6 as a user packet becomes a stack of IPv6 header+SRH+MAP-E (IPv6 header+IPv4 packet), and the overhead caused by adding the header is large.

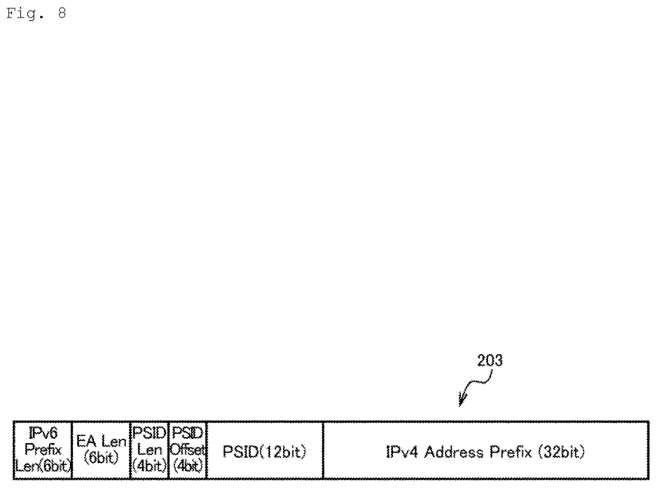

Even in the packet P13b of FIG. 6 obtained by partially omitting the SRH from the packet P13 a of FIG. 5 using the above-mentioned compression method, it is not possible to encapsulate an IPv4 packet with normal H.Encaps. Accordingly, the IPv6 header is doubly encapsulated as the compressed SRH 121 for SRv6 and the IPv6 header of MAP-E 101, and the overhead caused by adding the headers is large. Thus, the SR tunneling unit 33b of the present embodiment further improves compression efficiency using the proposed method shown in FIG. 7.

FIG. 7 is a packet diagram of a packet P13c generated by the SR tunneling unit 33b of the present embodiment.

The packet P13c includes a mixed IPv6 header 201 and a user's IPv4 packet 202. The IPv4 packet 202 is the same as the IPv4 packet 102 in FIG. 6.

The mixed IPv6 header 201 has both the information of the compressed SRH 121 for SRv6 in FIG. 6 and the information of the IPv6 header of MAP-E 101. The mixed IPv6 header 201 includes the following information.
The IPv6 header (RFC 8200 standard) in a first row is included in the compressed SRH 121 for SRv6 in FIG. 6.
“Source IPv6 Address” in a second row includes MAP data (an IPv6 Prefix allocated from a telecommunications carrier) in the second row of the IPv6 header of MAP-E 101 in the first half (64 bits). Interface-ID (64 bits) in a second half in a second row is defined as an “interface part 203,” and the interface part 203 includes the MAP rule 33c of MAP-E. That is, the SR tunneling unit 33b treats both the CE 33 and the BR 32 as nodes in an SRv6 domain.
“Destination IPv6 Address” in a third row is included in the compressed SRH 121 for SRv6 in FIG. 6. That is, the third line in FIG. 7 is an example in which, similarly to FIG. 6, compression is performed using the NEXT-C-SID Flavor, the SRH is omitted using H.Encaps.RED, and the final destination of SRv6 is set to the BR 32.

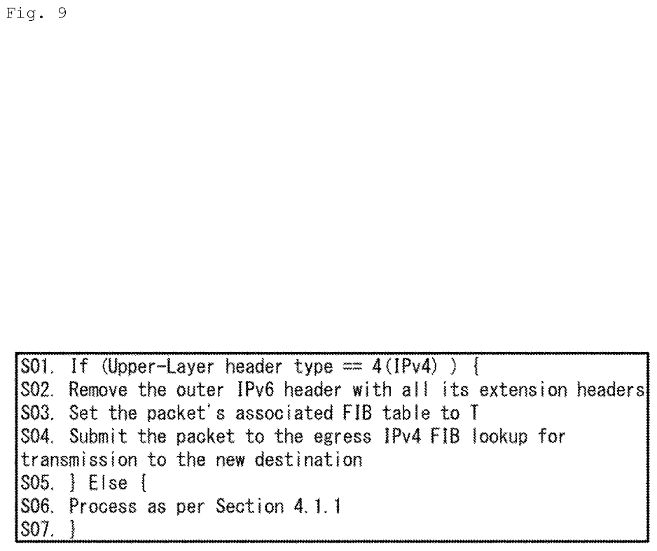

FIG. 8 is a packet diagram showing details of the interface part 203 of the present embodiment in FIG. 7.

The interface part 203 includes the following information in order from the left side in the figure.
IPv6 Prefix length (6- bit length=value 0-value 63) in a first column is a prefix length (/1-/64) in Rule IPv6 Prefix of the MAP rule 33c. For example, if the Rule IPv6 Prefix=“2001:db8:1000::/40”, Prefix Length=40 is satisfied.

As a premise, a prefix including Subnet ID of an IPv6 address allocated according to the definition of RFC 4291 IP version 6 Addressing Architecture “2.5.4. Global Unicast Addresses” is 64 bits long. The IPv6 address is allocated from the Internet Assigned Numbers Authority (IANA).

In the IPv6 Prefix, in reality,::/0 (used to represent routes for the entire IPv6 Internet, Default Route, and the like) is not selected as the Rule IPv6 Prefix. Accordingly, 64 possibilities from/1 to/64 are expressed as 6 bits 06000000 to 0b111111 (0 to 63 as a decimal number), and this is a value obtained by applying −1 to the actual Prefix length.
EA Len (6 bits) in a second column is an EA-bit length of the MAP rule 33c. EA-bit is “IPv4 Address Suffix+PSID.” EA Len is in the range of 0b000000 to 0b110000 (0 to 48 as a decimal number). The minimum value 0 means that there is no IPv 4 Suffix and PSID. The maximum value 48 indicates IPv4 Address Suffix: 32 bits+Port: 16 bits.
PSID Len (4 bits) in a third column is a PSID length of the MAP rule 33c. PSID Len is a value obtained by applying −1 to the actual length, and the actual value is in the range of 1 to 16 as a decimal number. The PSID may be 0 bit in NPL 1, but the present specification assumes the Shared IPv4 Address of NPL 1, and thus the PSID is assumed to be 1 or greater.
PSID Offset (4 bits) in a fourth column is a PSID offset of the MAP rule 33 c. The PSID Offset is in the range of 0 to 15 as a decimal number.
PSID (12 bits) in a fifth column is a part of the MAP data.
IPv4 Address Prefix (32 bits) in a sixth column may be a part of the MAP data, or the Rule IPv4 Prefix of the MAP rule 33c. In addition, in the MAP-E method, the lower 48 bits are embedded in the order of Source IPv4 Address+PSID, but in the present method, they are reversed.

Also, the maximum length of the PSID in the fifth column is 16 bits, but in order to exclude well-known ports less than 1024, the PSID offset is generally considered to take 6 bits as the MAP-E defualt, and take 10 bits or less. If the length of the PSID is 13 bits or more, a part of the PSID cannot be expressed, but the PSID is included in both IPv6 Prefix and Source Port. Accordingly, since it is allowable for a part of the PSID not to be expressed, the PSID is expressed before Source IPv4 Address, and has a form of allowing for partial overwriting.

In this way, the interface part 203 partially shortens the length of the information (MAP rule 33c) required for validation of the address or port to 20 bits (IPv6 Prefix Length in the first column to PSID Offset in the fourth column).

Also, as a comparative example, in draft-ietf-spring-sr-service-programming-06, support for both MPLS and IPv6 data planes has been studied. On the other hand, since additional information of the interface part 203 of the present embodiment is 20 bits, it is also applicable to SR-MPLS. In addition, in the present embodiment, the interface part 203 is embedded in the “Source IPv6 Address” in the second row of the mixed IPv6 header 201, but its main part is 20 bits, and thus a form in which it is embedded in the flow label, for example, is also possible.

Further, since an address sharing method with the SRv6 is integrated in the packet P13c, unnecessary overhead is not imparted to the packet format. In addition, in order to constitute the SR tunneling unit 33b of the CE 33, only a minor extension such as a change in the generation method of the IPv6 Address is applied. Accordingly, since the processing of H.Encaps or H.Encaps.RED of SRv6 defined in NPL 4, which is the basic mechanism of the CE 33 does not change, development costs therefor can be reduced.

Also, an SRH is required to enable transfer from each of the routers R11 to R28 serving as the relay device to the BR 32.

This relay device is a device that is intentionally intended to pass through, but a case in which an SID is inserted to utilize TI-LFA as a fast switching method when a failure occurs is also included.

If the CE 33 and the BR 32 belong to the same SRv6 domain, the decapsulation performed by the BR 32 corresponds to the processing of End. DT4 in NPL 4. However, in End.DT4, the function of verifying the Source IPv6 Address, the Source IPv4 Address in the encapsulated IPv4 packet, and the Source Port of the upper layer is not defined, and thus this function is additionally required. Thus, the device (router R27 in FIG. 1) that performs validation according to the present embodiment performs extension shown in FIG. 10 on End. DT4 of SRv6 (NPL 4) shown in FIG. 9.

FIG. 9 shows pseudocode defined in “4.7. End.DT4: Decapsulation and Specific IPv4 Table Lookup” in NPL 4 as verification code prepared in S11.

“S01” to “S07” on the left side of each row indicate row numbers. In “S02” in the second row, decapsulation (remove the outer IPv6 header) is performed.

FIG. 10 is pseudocode inserted between S01 and S02 of the pseudocode of FIG. 9 as verification code prepared in S11.

The pseudocode of FIG. 10 is executed by the device (router R27 in FIG. 1) that performs validation and decapsulation on the receiving side in order to verify the PSID and the IPv4 address. Also, determination of whether or not the pseudocode shown in FIG. 10 is to be executed can be distinguished by an identifier of Endpoint Behavior (designated in an IPv6 header of an outgoing packet) in SRv6 programming.

Here, the numerals in [] in FIG. 10 represents the number of bits from a leading head (starting from 0) of data, and the sign “:” represents a range. As an example, [64:191] refers to 128 bits from the 64th bit to the 191st bit. However, this pseudocode example does not assume fragmentation, and is written on the assumption that an IPv4 header has no extension option and the transport layer is TCP/UDP.

Also, packets corresponding to at least one of conditional statements 211 to 213 in FIG. 10 are discarded.

The conditional statement 211 indicates a case in which the IPv4 address in the IPv4 packet 202 does not coincide with the “IPv4 Address Prefix (32 bits)” in the sixth row in the interface part 203.

The conditional statement 212 indicates a case in which the IPv4 address suffix in the IPv4 packet 202 does not coincide with the “IPv4 Address suffix,” which is the higher bits of the EA bits in the second row and the second column of the mixed IPv6 header 201.

The conditional statement 213 indicates a case in which the PSID in the port in the IPv4 packet 202 does not coincide with the PSID in the “IPv6 Prefix” in the third row and the first column of the mixed IPv6 header 201.

The router R27 can acquire each parameter in the packet referred to by the conditional statements 211 to 213 in accordance with the MAP rule 33c embedded in the interface part 203. Thus, SRv6 nodes other than the BR 32, such as the router R27, can perform functions equivalent to those achieved by MAP-E, even if the MAP rule 33c is not set in advance.

### Effects

The present invention provides the CE 33 used in the communication system 100 configured to transmit an outgoing packet from the transmitting device 34 to the receiving device 31, wherein the CE 33 includes:
the SR tunneling unit 33b configured to receive the outgoing packet with an IPv4 header attached from the transmitting device 34,
generate the second parameter group obtained by converting the first parameter group read from the IPv4 header on the basis of the MAP rule 33c, and
encapsulate an IPv6 header including the second parameter group and the MAP rule 33c into the IPv4 header of the outgoing packet to transmit the outgoing packet to the BR 32 configured to decapsulate the outgoing packet.

Thus, the CE 33 causes the outgoing packet to directly include the MAP rule 33c, and thus decapsulation at any node corresponding to the SRv6 becomes possible. Accordingly, the CE 33 can efficiently set the route for the encapsulated packet.

The SR tunneling unit 33b of the present invention causes the information indicating the bit length of each parameter group included in the second parameter group to be included in the IPv6 header as the MAP rule 33c.

Thus, the CE 33 can execute verification processing with higher flexibility with respect to parameters of variable bit length.

The SR tunneling unit 33b of the present invention causes the second parameter group and the MAP rule 33c to be included in its own address information in the IPv6 header to encapsulate the outgoing packet.

Thus, the CE 33 can embed the information in a location that does not affect relay processing of the outgoing packet, such as in its own address information, thereby appropriately reducing an amount of data of the outgoing packet.

The SR tunneling unit 33b of the present invention further causes the address information indicating the relay route through which the outgoing packet passes to the BR 32 to also be included in the IPv6 header encapsulated in the outgoing packet to encapsulate the outgoing packet.

Thus, the CE 33 can use one header for both the IPv6 header for performing tunneling for MAP-E and the IPv6 header for designating the relay route of the SRv6. For that reason, the packet header length is reduced, and the transfer efficiency is improved.

Accordingly, it is possible to combine the IPv4 over IPv6 technology such as MAP-E/MAP-T, which performs stateless conversion in a telecommunications carrier network, with the SRv6 function for performing route designation and function designation, thereby inhibiting the packet overhead to the minimum.

The present invention provides a communication system 100 including the CE 33 and the BR 32, wherein the BR 32
decapsulates the IPv6 header of the encapsulated outgoing packet received from the CE 33 to acquire the second parameter group from the IPv6 header on the basis of the MAP rule 33c included in the IPv6 header, and
compares the first parameter group read from the IPv4 header of the decapsulated outgoing packet with the acquired second parameter group to perform verification processing for determining whether the outgoing packet is to be discarded or transferred to the receiving device 31.

Thus, the role of the BR 32 can be played by any node, not just the BR 32 with the MAP rule 33c set in advance.

### REFERENCE SIGNS LIST

11 Receiving device
12 BR
13 CE
13a NAT function unit
13b MAP-E function unit
14 Transmitting device
22, 23 MAP rule
31 Receiving device
32 BR (decapsulation device)
33 CE (encapsulation device)
33a NAT function unit
33b SR tunneling unit
33c MAP rule
34 Transmitting device
100, 100B Communication system

1. An encapsulation device used in a communication system configured to transmit a data packet from a transmitting device to a receiving device, wherein the encapsulation device includes:
a tunneling unit using one or more processors and configured to:
receive the data packet with an inner header attached from the transmitting device,
generate a second parameter group obtained by converting a first parameter group read from the inner header on the basis of a conversion rule, and
encapsulate an outer header including the second parameter group and the conversion rule into the inner header of the data packet to transmit the encapsulated data packet toward a decapsulation device configured to decapsulate the data packet.

2. The encapsulation device according to claim 1, wherein the tunneling unit causes information indicating a bit length of each parameter group included in the second parameter group to be included in the outer header as the conversion rule.

3. The encapsulation device according to claim 1, wherein the tunneling unit causes the second parameter group and the conversion rule to be included in its own address information in the outer header to encapsulate the data packet.

4. The encapsulation device according to claim 1, wherein the tunneling unit further causes address information indicating a relay route through which the data packet passes to the decapsulation device to also be included in the outer header encapsulated in the data packet to encapsulate the data packet.

5. A communication system comprising:
an encapsulation device configured to transmit a data packet from a transmitting device to a receiving device, wherein the encapsulation device includes a tunneling unit implemented using one or more processors, wherein the encapsulation device is configured to:
receive a data packet with an inner header attached from the transmitting device,
generate a second parameter group obtained by converting a first parameter group read from the inner header on the basis of a conversion rule, and
encapsulate an outer header including the second parameter group and the conversion rule into the inner header of the data packet to transmit the encapsulated data packet toward a decapsulation device configured to decapsulate the data packet; and
a decapsulation device, wherein the decapsulation device is configured to decapsulate the outer header of the encapsulated data packet received from the encapsulation device to acquire the second parameter group from the outer header based on the conversion rule included in the outer header, and
compare the first parameter group read from the inner header of the decapsulated data packet with the acquired second parameter group to perform verification processing for determining whether the data packet is to be discarded or transferred to the receiving device.

6. An encapsulation method used in an encapsulation device used in a communication system configured to transmit a data packet from a transmitting device to a receiving device, wherein the encapsulation device performs operations including:
receiving the data packet with an inner header attached from the transmitting device,
generating a second parameter group obtained by converting a first parameter group read from the inner header on the basis of a conversion rule, and
encapsulating an outer header including the second parameter group and the conversion rule into the inner header of the data packet to transmit the encapsulated data packet toward a decapsulation device configured to decapsulate the data packet.

7. (canceled)
